(19) United States
(12) Patent Application Publication
(10) Pub. No.: US 2010/0319472 A1
(43) Pub. Date: Dec. 23, 2010

(54) Protection device for actuator

(75) Inventors: Chia-Chun Wei, Taichung City (TW); Kuo-En Tseng, Taichung City (TW)

Correspondence Address: CHARLES E. BAXLEY, ESQUIRE, 90 JOHN STREET, SUITE 403, NEW YORK, NY, 10038, US

(73) Assignee: Hiwin Mikrosystem Corp.

(21) Appl. No.: 12/456,484

(22) Filed: Jun. 17, 2009

(51) Int. Cl. F16H 25/20

(52) U.S. Cl. 74/89.37

(57) ABSTRACT

A protection device for an actuator includes a buffer assembly assembled to an open end of a screw in the actuator. Thereby, when the actuator reaches its extension limit stop or retraction limit stop, the buffer assembly buffs excessive impact among internal components in the actuator.

### BACKGROUND OF THE INVENTION

1. Technical Field

The present invention relates to actuators, and more particularly, to a protection device acting as a buffer for protecting internal components of an actuator from excessive impact at the time the actuator reaches its extension limit stop or retraction limit stop.

2. Description of Related Art

Referring to FIG. 1, a conventional actuator primarily comprises a screw driver 10 connected with a screw 11, wherein the screw driver 10 is attached to one end of an outer tube 12 of the actuator so that the screw 11 extends in the outer tube 12. The actuator further has a nut 13 assembled to the screw 11 and an inner tube 14 that has one end coupled with the nut 13 and extends inside the outer tube 12, wherein a limit element 15 is provided at a distal end on the screw 11. In operation, the screw driver 10 drives the screw 11 to rotate so that the nut 13 moves along the screw 11 and in turn makes the inner tube 14 to move back and forth along an axis of the outer tube 12, thereby accomplishing extension and retraction of the actuator. During the foregoing operation, the nut 13 arriving at the distal end of the screw 11 is retained by the limit element 15 and thus prevented from leaving the screw 11.

Traditionally, there are two ways for actuators to give out stop signals when extending or retracting to the most.

The first approach involves using an electronic switch that relies on contact control or magnetic induction to provide signal feedback and then to stop an actuator.

The other approach is over-current control. That is, when an actuator reaches its extension limit stop or retraction limit stop, impact among its internal components incurs unusual stress that provides a controller with an unusual current so that the controller stops the actuator.

However, in applications of the latter approach, the involved components tend to be damaged under excessive impact thereof caused by the synergistic effect of the actuator's excessive output and transmission velocity. Among others, the drive gears, the screw, and the nut are those most likely to get damaged.

### SUMMARY OF THE INVENTION

In view of the shortcomings of the prior art, one objective of the present invention is to provide a protection device for an actuator, wherein the protection device buffs excessive impact among internal components of the actuator at the time the actuator reaches its extension limit stop or retraction limit stop, so as to protect a screw and a nut of the actuator.

The protection device is a buffer assembly coaxially assembled to an open end of the screw in the actuator. The buffer assembly has a first end and a second end that are axially opposite to each other. The first end has a first contacting surface while the second end has a second contacting surface. The first contacting surface is for being contacted by a drive nut mounted around the screw when the actuator reaches an extension limit stop. The second contacting surface is for being contacted by an inner tube plug assembled to an inner tube when the actuator reaches a retraction limit stop.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a sectional view of a conventional actuator;

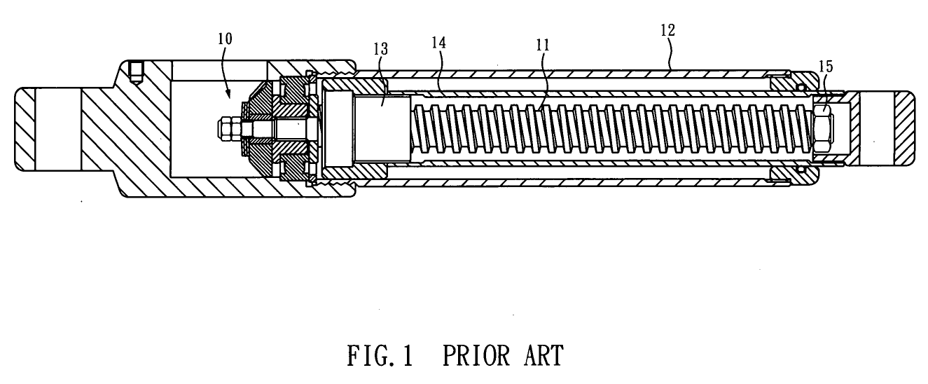

FIG. 2 shows a screw of an actuator and a protection device according to the present invention;

FIG. 3 is a sectional view of the actuator assembled with the protection device of the present invention, showing an inner tube of the actuator reaching a retraction limit;

FIG. 4 is a partially enlarged view of FIG. 3; and

FIG. 5 is another sectional view of the actuator assembled with the protection device of the present invention, showing the inner tube of the actuator reaching an extension limit.

### DETAILED DESCRIPTION OF THE PREFERRED EMBODIMENT

While preferred embodiments are provided hereinafter for illustrating the concept of the present invention as described above, it is to be understood that the components of the embodiments shown in the accompanying drawings are depicted for the sake of easy explanation and need not to be made in scale.

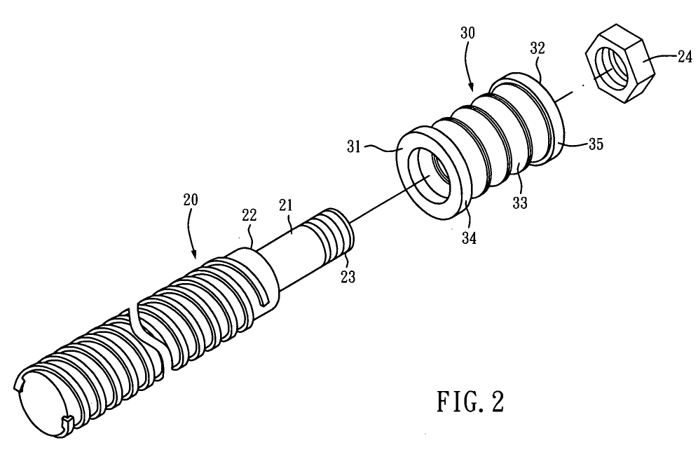

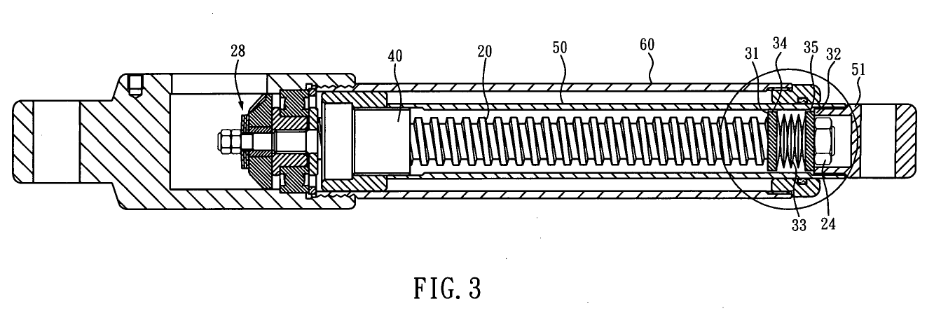

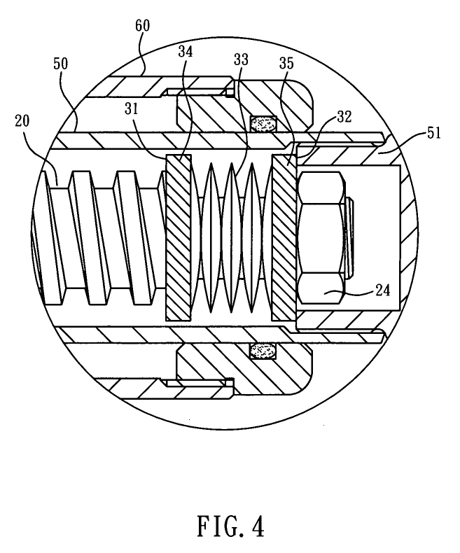

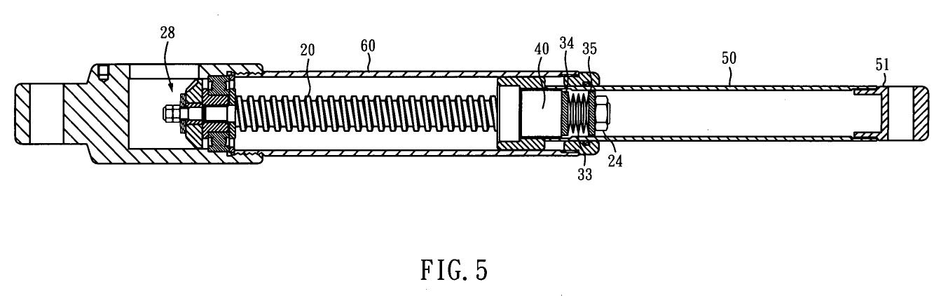

FIGS. 2 through 5 illustrate a protection device for an actuator according to the present invention. The protection device is a buffer assembly 30 coaxially assembled to an open end of a screw 20 in the actuator. The buffer assembly 30 has a first end and a second end that are axially opposite to each other, wherein the first end has a first contacting surface 31 while the second end has a second contacting surface 32. The first contacting surface 31 is for being contacted by a drive nut 40 mounted around the screw 20 when the actuator reaches an extension limit stop. The second contacting surface 32 is for being contacted by an inner tube plug 51 assembled to an inner tube 50 when the actuator reaches a retraction limit stop.

A driving device 28 of the actuator drives the screw 20 to rotate and in turn makes the drive nut 40 move back and forth along the screw 20. Consequently, the inner tube 50 assembled to the drive nut 40 is driven by the drive nut 40 to move back and forth in an outer tube 60 of the actuator. The actuator implements the foregoing over-current control to give stop signals when reaching either the extension limit stop or the retraction limit stop. When the inner tube 50 reaches the extension limit stop, the drive nut 40 comes into contact with the first contacting surface 31 and begins to press the buffer assembly 30. From this time on, the current in the actuator increases gradually due to the counterforce acting on the inner tube 50. When the current reaches a preset over-current threshold, the actuator stops extending. On the other hand, when the inner tube 50 reaches the retraction limit stop, the inner tube plug 51 comes into contact with the second contacting surface 32 and begins to press the buffer assembly 30. Similarly, when the current in the actuator finally reaches the preset over-current threshold, the actuator stops retracting.

In the embodiment shown in the drawings, the buffer assembly 30 comprises a spring 33 axially sandwiched between a first annular member 34 and a second annular member 35. The two annular members 34, 35 have their opposite surfaces acting as the first contacting surface 31 and the second contacting surface 32, respectively. The screw 20 has a diametrically-reduced section 21 that defines a retaining portion 22 on the screw 20. A threaded section 23 is formed at an open end of the diametrically-reduced section 21 for being coupled with a positioning nut 24. The two annular members 34, 35 each have an inner diameter closely fitting an outer diameter of the diametrically-reduced section 21, so that the buffer assembly 30 is firmly positioned on the diametrically-reduced section 21 without getting loosed. The first annular member 34 abuts against and thus gets positioned by the retaining portion 22. Then the positioning nut 24 screwed to the threaded section 23 abuts against and thereby positions the second annular member 35. As a result, the buffer assembly 30 is mounted around the diametrically-reduced section 21 firmly. Besides, the first annular member 34 and the second annular member 35 each have an outer diameter greater than a diameter of the screw 20 so as to allow the drive nut 40 and the inner tube plug 51 to contact therewith, respectively.

On the strength of its deformability that absorbs excessive impact when the actuator reaches its extension limit stop or retraction limit stop, the buffer assembly 30 provides a function of buffing and thus effectively protects the screw 20 and the drive nut 40.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A protection device for an actuator, the protection device comprising:
a buffer assembly that is coaxially assembled to an open end of a screw in the actuator, wherein the buffer assembly includes axially opposite a first end having a first contacting surface and a second end having a second contacting surface.

2. The protection device of claim 1, wherein the buffer assembly comprises a spring that is axially sandwiched between a first annular member and a second annular member, and the two annular members have opposite surfaces thereof acting as the first contacting surface and the second contacting surface, respectively.

3. The protection device of claim 2, wherein the screw has a diametrically-reduced section that defines a retaining portion on the screw, and the screw has a threaded section formed at an open end of the diametrically-reduced section for being coupled with a positioning nut.

4. The protection device of claim 3, wherein each of the two annular members has an inner diameter closely fitting the diametrically-reduced section.

5. The protection device of claim 3, wherein each of the two annular members has an outer diameter greater than a diameter of the screw.
